(19) United States
(12) Patent Application Publication
(10) Pub. No.: US 2022/0346382 A1
(43) Pub. Date: Nov. 3, 2022

(54) COMPOSITION FOR TREATING AND PREVENTING BACTERIAL GROWTH ON A SUBSTRATE

(71) Applicant: PETROLIAM NASIONAL BERHAD (PETRONAS), Kuala Lumpur (MY)

(72) Inventors: Hasrizal Bin ABD RAHMAN, Kuala Lumpur (MY); Intan Khalida Binti SALLEH, Kuala Lumpur (MY); Nik Nor Azrizam Bin NIK NORIZAM, Kuala Lumpur (MY)

(21) Appl. No.: 17/624,287

(22) PCT Filed: Jun. 14, 2020
(86) PCT No.: PCT/MY2020/050042

§ 371 Date: Dec. 31, 2021

(30) Foreign Application Priority Data
Jul. 4, 2019 (MY) PI 2019003893

(51) Int. Cl. A01N 59/26; A01N 25/02

(52) U.S. Cl. CPC A01N 59/26; A01N 25/02

(57) ABSTRACT

Disclosed herein is a composition for treating bacteria growth on a substrate, the composition comprising a biocide and at least one D-amino acid.

### FIELD OF INVENTION

The invention relates to a composition for treating bacteria growth on a substrate.

### BACKGROUND

The listing or discussion of a prior-published document in this specification should not necessarily be taken as an acknowledgement that the document is part of the state of the art or is common general knowledge.

Microbiologically-induced corrosion or microbiologically influenced corrosion (MIC) is a serious problem in the oil and gas industry. MIC may be defined as the possibility that microorganisms are involved in the deterioration of metallic as well as non-metallic materials. Depending on the environment, these microbes may include metal-oxidizing bacteria, sulfate-reducing bacteria (SRB), acid-producing bacteria (APB), metal-reducing bacteria (MRB).

As localised corrosion may lead to serious problems such as internal leaks in pipelines, a lot of money has been spent on mitigating MIC in ageing pipelines worldwide, including in Malaysia. A conventional method of controlling MIC is to inject a biocide into the pipelines. However, a relatively high concentration of biocide is generally used, incurring high costs.

There is therefore a need for an improved solution to control MIC that is also more cost-effective.

### SUMMARY OF INVENTION

In a first aspect of the invention, there is provided a composition for treating bacteria growth on a substrate, the composition comprising a biocide and at least one D-amino acid.

In an embodiment of the first aspect of the invention, the composition may further comprise water.

In further embodiments of the invention, the at least one D-amino acid may be selected from one or more of the group consisting of D-tyrosine, D-methionine, D-tryptophan, D-leucine, D-arginine, D-histidine, D-lysine, D-aspartic acid, D-glutamic acid, D-serine, D-threonine, D-asparagine, D-glutamine, D-cysteine, D-proline, D-alanine, D-valine, D-isoleucine, D-phenylalanine and a non-standard D-amino acid.

In further embodiments of the invention, the biocide may be selected from one or more of the group consisting of tetrakis hydroxymethyl phosphonium sulfate (THPS), chlorine monoxide, chlorine dioxide, calcium hypochlorite, potassium hypochlorite, sodium hypochlorite, dibromonitriloproprionamide (DBNPA), methylene bis(thiocyanate) (MBT), 2-(thiocyanomethylthio) benzothiazole (TCMTB), bronopol, 2-bromo-2-nitro-1,3-propanediol (BNPD), tributyl tetradecyl phosphonium chloride (TTPC), taurinamide and derivatives thereof, phenols, quaternary ammonium salts, chlorine-containing agents, quinaldinium salts, lactones, organic dyes, thiosemicarbazones, quinones, carbamates, urea, salicylamide, carbanilide, guanide, amidines, imidazolines, acetic acid, benzoic acid, sorbic acid, propionic acid, boric acid, dehydroacetic acid, sulfurous acid, vanillic acid, p-hydroxybenzoate esters, isopropanol, propylene glycol, benzyl alcohol, chlorobutanol, phenylethyl alcohol, formaldehyde, iodine and solutions thereof, povidone-iodine, hexamethylenetetramine, noxythiolin, 1-(3-chloroallyl)-3,5,7-triazo-1-azoniaadamantane chloride, taurolidine, taurultam, N-(5-nitro-2-furfurylidene)-1-amino-hydantoin, 5-nitro-2-furaldehyde semicarbazone, 3,4,4′-trichlorocarbanilide, 3,4′,5-tribromosalicylanilide, 3-trifluoromethyl-4,4′-dichlorocarbanilide, 8-hydroxyquinoline, 1-cyclopropyl-6-fluoro-1,4-dihydro-4-oxo-7-(1-piperazinyl)-3-quinolinecarboxylic acid, 1,4-dihydro-1-ethyl-6-fluoro-4-oxo-7-(1-piperazinyl)-3-quinolinecarboxylic acid, hydrogen peroxide, peracetic acid, sodium oxychlorosene, parachlorometaxylenol, 2,4,4′-trichloro-2′-hydroxydiphenol, thymol, chlorhexidine, benzalkonium chloride, cetylpyridinium chloride, silver sulfadiazine, silver nitrate, bromine, ozone, isothiazolones, polyoxyethylene (dimethylimino) ethylene (dimethylimino) ethylene dichloride and 2-(tert-butylamino)-4-chloro-6-ethylamino-5′-triazine (terbutylazine).

In yet further embodiments of the invention:

(a) the weight to weight ratio of the at least one D-amino acid to the biocide may be from 0.5 to 50:1, such as from 1.5 to 5:1 (e.g. from 2.1 to 2.7:1);

(b) the composition may comprise at least two D-amino acids, optionally wherein the weight to weight ratio of the at least two D-amino acids to the biocide is from 0.5 to 50:1, such as from 1.5 to 5:1 (e.g. from 2.1 to 2.7:1);

(c) the at least one D-amino acid may be D-tryptophan;

(d) the at least one D-amino acid may be D-tryptophan and D-methionine, optionally wherein the weight to weight ratio of D-tryptophan to D-methionine is from 2 to 20:1, such as from 4 to 10:1 (e.g. from 6 to 7:1); and/or

(e) the biocide may be tetrakis hydroxymethyl phosphonium sulfate (THPS)

In yet further embodiments of the invention, the composition may be one in which:
the at least one D-amino acid is D-tryptophan and D-methionine; and
the biocide is tetrakis hydroxymethyl phosphonium sulfate (THPS).

In still yet further embodiments of the invention, the composition may be one in which:

(a) the weight to weight ratio of D-tryptophan to D-methionine is from 2 to 20:1 and the weight to weight ratio of the D-amino acids to THPS is from 0.5 to 50:1;

(b) the weight to weight ratio of D-tryptophan to D-methionine is from 4 to 10:1 (such as from 6 to 7:1), and the weight to weight ratio of the D-amino acids to THPS is from 1.5 to 5:1 (such as from 2.1 to 2.7:1);

(c) wherein, when no solvent or water is present:
D-tryptophan is present in an amount of 61 wt %;
D-methionine is present in an amount of 9 wt %; and
THPS is present in an amount of 30 wt %; or

(d) when the composition further comprises water, the composition consisting:
61 ppm of D-tryptophan;
9 ppm of D-methionine;
30 ppm of THPS;
with the balance being water; or
610 ppm of D-tryptophan;
90 ppm of D-methionine;
300 ppm of THPS;
with the balance being water.

In a second aspect of the invention, there is provided a process of treating bacteria growth on a substrate, which process comprises contacting the substrate with a composition as defined in the first aspect of the invention and any technically sensible combination of its embodiments.

In embodiments of the second aspect of the invention:

(a) the biocide and the at least one D-amino acid may be separately or simultaneously added to a medium that contacts the substrate, optionally wherein the medium is water or a water/oil mixture and the substrate is one of a metal, a metal alloy, nylon, plastic, composite material, wood, glass, ceramic, porcelain, a painted surface, rock, or soil; and/or

(b) the composition reduces the bacteria count on the substrate and/or reduces the rate of corrosion of the substrate.

In the above aspects of the invention and any technically sensible combination of their embodiments, the bacteria to be treated may be selected from one or more of group consisting of Bacillus sp., Bacillus thuringiensis and Marine actinomycetes.

Further aspects and embodiments of the invention are contained in the following numbered clauses.

1. A composition for treating bacteria growth on a substrate, the composition comprising:
a biocide; and
at least one D-amino acid.

2. The composition according to Clause 1, wherein the composition further comprises water.

3. The composition according to any one of the preceding clauses, wherein the D-amino acid is selected from one or more of the group consisting of D-tyrosine, D-methionine, D-tryptophan, D-leucine, D-arginine, D-histidine, D-lysine, D-aspartic acid, D-glutamic acid, D-serine, D-threonine, D-asparagine, D-glutamine, D-cysteine, D-proline, D-alanine, D-valine, D-isoleucine, D-phenylalanine and a non-standard D-amino acid.

4. The composition according to any one of the preceding clauses, wherein the biocide is selected from one or more of the group consisting of tetrakis hydroxymethyl phosphonium sulfate (THPS), chlorine monoxide, chlorine dioxide, calcium hypochlorite, potassium hypochlorite, sodium hypochlorite, dibromonitriloproprionamide (DBNPA), methylene bis(thiocyanate) (MBT), 2-(thiocyanomethylthio) benzothiazole (TCMTB), bronopol, 2-bromo-2-nitro-1,3-propanediol (BNPD), tributyl tetradecyl phosphonium chloride (TTPC), taurinamide and derivatives thereof, phenols, quaternary ammonium salts, chlorine-containing agents, quinaldinium salts, lactones, organic dyes, thiosemicarbazones, quinones, carbamates, urea, salicylamide, carbanilide, guanide, amidines, imidazolines, acetic acid, benzoic acid, sorbic acid, propionic acid, boric acid, dehydroacetic acid, sulfurous acid, vanillic acid, p-hydroxybenzoate esters, isopropanol, propylene glycol, benzyl alcohol, chlorobutanol, phenylethyl alcohol, formaldehyde, iodine and solutions thereof, povidone-iodine, hexamethylenetetramine, noxythiolin, 1-(3-chloroallyl)-3,5,7-triazo-1-azoniaadamantane chloride, taurolidine, taurultam, N-(5-nitro-2-furfurylidene)-1-amino-hydantoin, 5-nitro-2-furaldehyde semicarbazone, 3,4,4′-trichlorocarbanilide, 3,4′,5-tribromosalicylanilide, 3-trifluoromethyl-4,4′-dichlorocarbanilide, 8-hydroxyquinoline, 1-cyclopropyl-6-fluoro-1,4-dihydro-4-oxo-7-(1-piperazinyl)-3-quinolinecarboxylic acid, 1,4-dihydro-1-ethyl-6-fluoro-4-oxo-7-(1-piperazinyl)-3-quinolinecarboxylic acid, hydrogen peroxide, peracetic acid, sodium oxychlorosene, parachlorometaxylenol, 2,4,4′-trichloro-2′-hydroxydiphenol, thymol, chlorhexidine, benzalkonium chloride, cetylpyridinium chloride, silver sulfadiazine, silver nitrate, bromine, ozone, isothiazolones, polyoxyethylene (dimethylimino) ethylene (dimethylimino) ethylene dichloride and 2-(tert-butylamino)-4-chloro-6-ethylamino-5′-triazine (terbutylazine).

5. The composition according to any one of the preceding clauses, wherein the weight to weight ratio of the at least one D-amino acid to the biocide is from 0.5 to 50:1, such as from 1.5 to 5:1 (e.g. from 2.1 to 2.7:1).

6. The composition according to any one of the preceding clauses, wherein the composition comprises at least two D-amino acids.

7. The composition according to any one of the preceding clauses, wherein the composition comprises at least two D-amino acids, and the weight to weight ratio of the at least two D-amino acids to the biocide is from 0.5 to 50:1, such as from 1.5 to 5:1 (e.g. from 2.1 to 2.7:1).

8. The composition according to any one of the preceding clauses, wherein the at least one D-amino acid is D-tryptophan.

9. The composition according to any one of Clauses 1 to 7, wherein the at least one D-amino acid is D-tryptophan and D-methionine.

10. The composition according to Clause 9, wherein the weight to weight ratio of the D-tryptophan to D-methionine is from 2 to 20:1, such as from 4 to 10:1 (e.g. from 6 to 7:1).

11. The composition according to any one of the preceding clauses, wherein the biocide is tetrakis hydroxymethyl phosphonium sulfate (THPS)

12. The composition according to any one of the preceding clauses, wherein:
the at least one D-amino acid is D-tryptophan and D-methionine; and
the biocide is tetrakis hydroxymethyl phosphonium sulfate (THPS).

13. The composition according to Clause 12, wherein the weight to weight ratio of D-tryptophan to D-methionine is from 2 to 20:1, such as from 4 to 10:1, and the weight to weight ratio of the D-amino acids to THPS is from 0.5 to 50:1, such as from 1.5 to 5:1.

14. The composition according to Clause 12, wherein the weight to weight ratio of D-tryptophan to D-methionine is from 4 to 10:1 (such as from 6 to 7:1), and the weight to weight ratio of the D-amino acids to THPS is from 1.5 to 5:1 (such as from 2.1 to 2.7:1).

15. The composition according to Clause 12 wherein, when no solvent or water is present:
D-tryptophan is present in an amount of 61 wt %;
D-methionine is present in an amount of 9 wt %; and
THPS is present in an amount of 30 wt %.

16. The composition according to Clause 12 wherein, when the composition further comprises water, the composition consisting of:

61 ppm of D-tryptophan;
9 ppm of D-methionine; and
30 ppm of THPS,
with the balance being water; or
610 ppm of D-tryptophan;
90 ppm of D-methionine; and
300 ppm of THPS,
with the balance being water.

17. A process of treating bacteria growth on a substrate, which process comprises contacting the substrate with a composition as defined in any one of Clauses 1 to 16.

18. The process according to Clause 17, wherein the biocide and the at least one D-amino acid are separately and sequentially added to a medium that contacts the substrate.

19. The process according to Clause 18, wherein the medium is water or a water/oil mixture.

20. The process according to any one of Clauses 17 to 19, wherein the substrate is one of a metal, a metal alloy, nylon, plastic, composite material, wood, glass, ceramic, porcelain, a painted surface, rock, or soil.

21. The process according to any one of Clauses 17 to 20, wherein the composition reduces the bacteria count on the substrate and/or reduces the rate of corrosion of the substrate.

22. The composition according to any one of Clauses 1 to 16, or the process according to any one of Clauses 17 to 21, where the bacteria to be treated is selected from one or more of group consisting of Bacillus sp., Bacillus thuringiensis and Marine actinomycetes.

### DRAWINGS

Certain embodiments of the present disclosure are described more fully hereinafter with reference to the accompanying drawings.

FIG. 1: Cell Dry Weight for a water sample produced from an oil field (“sample B04S”) on Day 7 as a function of the formulations tested.

FIG. 2: Cell Count for Sample B04S for each run on Day 3.

FIG. 3: Cell Count for Sample B04S for each run on Day 5.

FIG. 4: Cell Count for Sample B04S for each run on Day 7.

FIG. 5: Corrosion rate as a function of the formulations tested.

FIG. 6: Residual percentage of amino acid(s) in Formulation 1 (right axis) and bacteria cell count (left axis) as a function of test time.

FIG. 7: Cell count for Time Kill Test

FIGS. 8-16: SEM analysis of corrosion product layer of coupons immersed in specified formulations (a and b) with EDX analysis (c). Specific formulation used from FIGS. 8 to 16 (in order): blank; MT; TT; MT & TT; TT & THPS; MT & THPS; TT & MT & THPS; TT & 66.67 MT & THPS; and 66.67 TT & MT & THPS.

### DESCRIPTION

It is surprisingly found that a combination of a biocide and at least one D-amino acid result in a synergistic effect in treating bacteria growth on a substrate. As such, disclosed herein is a composition that overcomes some or all of the problems discussed above. That is, there is disclosed a composition for treating bacteria growth on a substrate, the composition comprising a biocide and at least one D-amino acid.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

In embodiments herein, the word “treating” or “treat”, unless otherwise specified, mean inhibit, mitigate, disinfect, damage, eliminate, reduce, eradicate, kill, prevent, remove, degrade, suppress, retard, or combinations thereof.

In embodiments herein, the word “bacteria” means any and all microorganisms capable of colonising, causing microbiologically-induced corrosion or microbiologically influenced corrosion (MIC). Examples of microbes that generally colonize and cause damage to pipelines in the gas and oil industries include, but are not limited to, Enterobacter and Citrobacter bacteria (e.g., E. dissolvens, E. ludwigii, C. farmer and C. amalonaticus); Eubacterium and Clostridium bacteria (e.g., Clostridium butyricum, Clostridium algidixylanolyticum, Anaeorfilum pentosovorans, Bacteroides sp., Acinobacter sp., Propionibacterium sp.); sulfate reducing bacteria including, but not limited to, Desulfovibrionales (e.g., Desulfovibrio desulfuricans, Desulfovibrio vulgaris, Desulfovibrio aminophilus); nitrate reducing bacteria; nitrite reducing bacteria; Desulfobacterales, and Syntrophobacterales; thiosulfate reducing anaerobes (e.g., Geotoga aestuarianis, Halanaerobium congolense, Sulfurospirillum sp.); tetracholoroethene degrading anaerobes (e.g., Sporomusa ovata); triethanolamine degrading bacteria (e.g., Acetobacterium sp.); denitrifiers (e.g., Acidovorax sp., Pseudomonas sp.); xylan degrading bacteria; Nitrospirae; Halomonas spp.; Idiomarina spp.; Marinobacter aquaeolei; Thalassospira sp.; Silicibacter sp.; Chromohalobacter sp.; Bacilli (e.g., Bacillus spp., Exiguobacterium spp.); Comamonas denitrificans; Methanobacteriales; Methanomicrobiales; and Methanosarcinales. In certain embodiments, the bacteria to be treated may be selected from one or more of group consisting of Bacillus sp., Bacillus thuringiensis and Marine actinomycetes.

In embodiments herein, the word “substrate” means any material that is susceptible to microbiologically-induced corrosion or microbiologically influenced corrosion (MIC). This includes any type of surface on which cells can attach and a biofilm can form and grow. In embodiments of the invention disclosed herein, the substrate may be selected from one of a metal, a metal alloy, nylon, plastic, composite material, wood, glass, ceramic, porcelain, a painted surface, rock, or soil.

The composition may be provided in a form that does not contain water or contains very little amount of water (0.01 to 1 wt %). However, the composition may in some cases contain water or be diluted with water before it is used to treat bacteria growth on a substrate. As such, the composition may also further comprise water.

Any D-amino acid may be used in the embodiments disclosed herein. The term “D-amino acid” may refer to any of the dextrorotary amino acid including but not limited to the enantiomers of the 19 naturally occurring L-amino acids. For example, the at least one D-amino acid may be selected from one or more of the group consisting of D-tyrosine, D-methionine, D-tryptophan, D-leucine, D-arginine, D-histidine, D-lysine, D-aspartic acid, D-glutamic acid, D-serine, D-threonine, D-asparagine, D-glutamine, D-cysteine, D-proline, D-alanine, D-valine, D-isoleucine, D-phenylalanine and a non-standard D-amino acid. In an embodiment of the invention, the at least one D-amino acid may be D-tryptophan.

In certain embodiments of the invention, the at least one D-amino acid is a mixture of two, three or more D-amino acids. In one embodiment, the composition may comprise at least two D-amino acids. The two, three or more D-amino acids may be selected from those listed hereinbefore. In certain embodiments, the at least two D-amino acids may be D-tryptophan and D-methionine.

The non-standard D-amino acid may be selected from the group consisting of carnitine, gamma-aminobutyric acid (GABA), beta-amino acids, gamma-amino acids, hypusine, selenocysteine, lanthionine, 2-aminoisobutyric acid, dehydroalanine, dehydrophenylalanine, phosphotyrosine, ornithine, citrulline, 3-aminopropionic acid, panthothenic acid, taurine, pyrrolysine, 5-hydroxytryptophan (5-HTP), dihydroxyphenylalanine (DOPA), and combinations thereof.

In embodiments herein, the biocide may be any agent that exhibits biocidal or antimicrobial properties. For example, the biocide may be selected from one or more of the group consisting of tetrakis hydroxymethyl phosphonium sulfate (THPS), chlorine monoxide, chlorine dioxide, calcium hypochlorite, potassium hypochlorite, sodium hypochlorite, dibromonitriloproprionamide (DBNPA), methylene bis(thiocyanate) (MBT), 2-(thiocyanomethylthio) benzothiazole (TCMTB), bronopol, 2-bromo-2-nitro-1,3-propanediol (BNPD), tributyl tetradecyl phosphonium chloride (TTPC), taurinamide and derivatives thereof, phenols, quaternary ammonium salts, chlorine-containing agents, quinaldinium salts, lactones, organic dyes, thiosemicarbazones, quinones, carbamates, urea, salicylamide, carbanilide, guanide, amidines, imidazolines, acetic acid, benzoic acid, sorbic acid, propionic acid, boric acid, dehydroacetic acid, sulfurous acid, vanillic acid, p-hydroxybenzoate esters, isopropanol, propylene glycol, benzyl alcohol, chlorobutanol, phenylethyl alcohol, formaldehyde, iodine and solutions thereof, povidone-iodine, hexamethylenetetramine, noxythiolin, 1-(3-chloroallyl)-3,5,7-triazo-1-azoniaadamantane chloride, taurolidine, taurultam, N-(5-nitro-2-furfurylidene)-1-amino-hydantoin, 5-nitro-2-furaldehyde semicarbazone, 3,4,4′-trichlorocarbanilide, 3,4′,5-tribromosalicylanilide, 3-trifluoromethyl-4,4′-dichlorocarbanilide, 8-hydroxyquinoline, 1-cyclopropyl-6-fluoro-1,4-dihydro-4-oxo-7-(1-piperazinyl)-3-quinolinecarboxylic acid, 1,4-dihydro-1-ethyl-6-fluoro-4-oxo-7-(1-piperazinyl)-3-quinolinecarboxylic acid, hydrogen peroxide, peracetic acid, sodium oxychlorosene, parachlorometaxylenol, 2,4,4′-trichloro-2′-hydroxydiphenol, thymol, chlorhexidine, benzalkonium chloride, cetylpyridinium chloride, silver sulfadiazine, silver nitrate, bromine, ozone, isothiazolones, polyoxyethylene (dimethylimino) ethylene (dimethylimino) ethylene dichloride and 2-(tert-butylamino)-4-chloro-6-ethylamino-5′-triazine (terbutylazine). In certain embodiments, the biocide may be tetrakis hydroxymethyl phosphonium sulfate (THPS).

In an embodiment of the invention, the weight to weight ratio of the at least one D-amino acid to the biocide may be from 0.5 to 50:1, such as from 1.5 to 5:1 (e.g. from 2.1 to 2.7:1). In embodiments where the composition comprises at least two D-amino acids, the weight to weight ratio of the at least two D-amino acids to the biocide may be from 0.5 to 50:1, such as from 1.5 to 5:1 (e.g. from 2.1 to 2.7:1). The weight of the at least two D-amino acids refers to the combined weight of all the D-amino acids present. In embodiments where the composition comprises D-tryptophan and D-methionine, the weight to weight ratio of the D-tryptophan to D-methionine may be from 2 to 20:1, such as from 4 to 10:1 (e.g. from 6 to 7:1).

In yet further embodiments of the invention, the composition may be one in which the at least one D-amino acid is D-tryptophan and D-methionine; and the biocide is tetrakis hydroxymethyl phosphonium sulfate (THPS). Any suitable ratio of each component may be used. For example in an embodiment, the weight to weight ratio of D-tryptophan to D-methionine is from 2 to 20:1 and the weight to weight ratio of the D-amino acids and THPS is from 0.5 to 50:1. The weight of the D-amino acids refers to the combined weight of all the D-amino acids present. In a further embodiment, the weight to weight ratio of D-tryptophan to D-methionine is from 4 to 10:1 (such as from 6 to 7:1), and the weight to weight ratio of the D-amino acids to THPS is from 1.5 to 5:1 (such as from 2.1 to 2.7:1). Without wishing to be bound by theory, it is believed that the use of components having the specified ratios may provide compositions that are particularly good in treating bacteria growth on a substrate, for example, with regard to bacteria count on the substrate, rate of corrosion of the substrate and/or time needed for a drop in bacteria population after injection of composition. For example, compositions having components in the specified ratios may give a lower bacteria count on the substrate, lower rate of corrosion and/or shorter time needed to observe a drop in bacteria population after injection of composition, compared to compositions that do not have the specified ratios.

In embodiments wherein, when no solvent or water is present, the composition may be one in which:
D-tryptophan is present in an amount of 61 wt %;
D-methionine is present in an amount of 9 wt %; and
THPS is present in an amount of 30 wt %.

The units of wt % are based on mass. For example, a 100 g composition has 61 g of D-tryptophan, 9 g of D-methionine and 30 g of THPS.

In embodiments when the composition further comprises water, the composition may be one consisting of:

(a) 61 ppm of D-tryptophan;
9 ppm of D-methionine; and
30 ppm of THPS,
with the balance being water; or

(b) 610 ppm of D-tryptophan;
90 ppm of D-methionine; and
300 ppm of THPS,
with the balance being water.

The units of ppm (parts per million) are based on mass (w/w). For example, a 1 ppm D-tryptophan solution has 1 mg of D-tryptophan per 1 kg of solution (e.g. water).

There is also disclosed a process of treating bacteria growth on a substrate, which process comprises contacting the substrate with a composition as defined hereinbefore.

The process may be implemented in a variety of ways. For example, in certain embodiments of the method, the at least one D-amino acid and the at least one biocide may be separately and simultaneously added to a medium that contacts, or wets, the substrate. In certain other embodiments, the at least one D-amino acid and the at least one biocide may be separately and sequentially added to a medium that contacts, or wets, the substrate. In still other embodiments, the at least one D-amino acid and the at least one biocide may be in a single solution that is added to a medium that contacts, or wets, the substrate. In the various embodiments of the method, the at least one D-amino acid and the at least one biocide may be added to the medium by one or more pumps, a gravity feed system, or even directly poured into the medium. Those with skill in the art will appreciate that other means for adding the at least one D-amino acid and the at least one biocide to the medium are available and may be utilized with the presently disclosed methods.

In certain embodiments of the method, the medium may be virtually any medium known to facilitate the formation and growth of a biofilm. For example, the medium may be water or a water/oil mixture.

In certain embodiments of the method, the composition may reduce the bacteria count on the substrate and/or reduces the rate of corrosion of the substrate. The bacteria count, cell count, or corrosion rate may be measured by any suitable method. For example, the cell count may be measured by ASTM Standard E 2315-03 (“Standard Guide for Assessment of Antimicrobial Activity”). The corrosion rate may be measured by weight loss of coupons after immersion in the composition in accordance with SP0775-2013, “Standard Practice, Preparation, Installation, Analysis, and Interpretation of Corrosion Coupons in Oilfield Operations,” (Houston, Tex.: NACE).

As discussed above, the compositions and methods disclosed herein are effective for treating bacteria growth on a substrate, such as bacteria that may lead to biofilm formation which may lead to MIC. The efficacy is believed to be a result of the synergy between the at least one D-amino acid and the at least one biocide. As demonstrated in the Examples, treatments with higher concentration of only at least one biocide or only at least one D-amino acid were not effective for treating bacteria growth or for eradicating established, recalcitrant biofilms, as the combination of at least one D-amino acid and at least one biocide. Moreover, the combination of at least one D-amino acid and at least one biocide may allow for a reduced dosage of the at least one biocide required for achieving effective biofilm treatment results. Thus, the presently disclosed compositions and methods may provide cost savings by reducing the amount of biocide required to treat biofilms, as well as reduce environmental exposure of the biocide.

Further details of the invention will now be described with reference to the following non-limiting examples.

### EXAMPLES

Material and methods

D-amino acids were purchased from Sigma Aldrich (laboratory grade and the purity is 100%). THPS was purchased from HB Lab

SEM imaging and EDX were performed using a HITACHI SU8020 (year of manufacture is 2012).

UV-visible spectroscopy was performed using a UV-VIS Spectrometer.

DOE software was obtained from Stat-Ease. Version of the software is Design Expert 9.

Bacteria Characterisation from Water Sample

Bacteria were isolated from produced water samples from an oil field (denoted as samples B04S and B24) in accordance with NACE TM0194-2014.

In sample B04S, Bacillus sp., Bacillus thuringiensis and Marine actinomycetes were identified. In sample B24, Bacillus thuringiensis and Marine actinomycetes were identified. Marine actinomycete was identified to be the main species that support biofilm stability and a growth environment for other species including sulphate-reducing bacteria (SRB).

### Example 1

### Formulation Design

Formulations were prepared by mixing the listed chemical components in the stated concentrations with produced water sample BO4S in a flask (Table 1). These formulations were tested in subsequent examples for biocide activity.

TABLE 1
Biocide formulations

| | Chemical components added | | |
|---|---|---|---|
| | THPS | D-Methionine | D-Tryptophan |
| Formulation name | (ppm) | (ppm) | (ppm) |
| Control | 0 | 0 | 0 |
| MT | 0 | 100 | 0 |
| MT + TT + THPS | 33.33 | 33.33 | 33.33 |
| TT + THPS | 50 | 0 | 50 |
| TT | 0 | 0 | 100 |
| TT + 66.67MT + THPS | 16.67 | 66.67 | 16.67 |
| MT + THPS | 50 | 50 | 0 |
| 66.67TT + MT + THPS | 16.67 | 16.67 | 66.67 |
| MT + THPS | 0 | 50 | 50 |
| THPS | 100 | 0 | 0 |

### Example 2

### Biocide Activity of Formulations Based on Cell Dry Weight and Cell Count

2.1 Cell Dry Weight

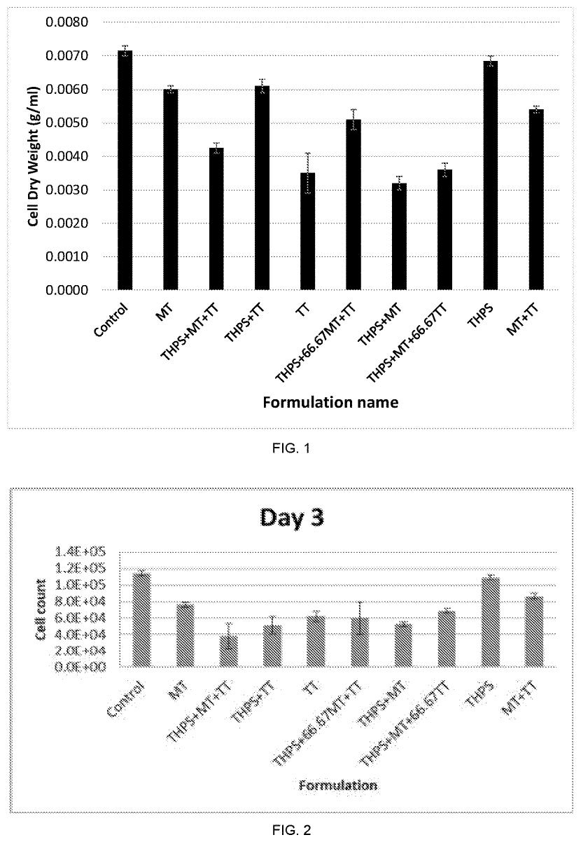

The formulations in Example 1 were cultured for seven days at ambient temperatures and static conditions in glass vials. Subsequently the cell dry weight of the formulations was quantified in accordance with NACE TM0194-2014. The cell dry weight for each formulation was reported in and/or converted to g/mL for comparison (FIG. 1).

The results show that the lowest cell dry weight (as compared to formulation THPS) was achieved by formulations MT+THPS and TT, which have a 53% and 40% lower cell dry weight, respectively.

2.2 Cell Count

The formulations in Example 1 were cultured and the viable cell count from suspension cells was determined at the 3^{rd}, 5^{th} and 7^{th} day from the initiation of the culture using a hemocytometer in accordance with ASTM Standard E 2315-03 (“Standard Guide for Assessment of Antimicrobial Activity”).

In a typical procedure, a glass hemocytometer and coverslip was cleaned with alcohol prior to use. The coverslip was moisturised with water and affixed to the hemocytometer. The presence of Newton's refraction rings under the coverslip indicated proper adhesion.

The flasks containing the formulations were gently swirled to ensure that the cells were evenly distributed. Before the cells settled to the bottom of the flasks, 0.5 mL of a cell suspension was transferred out to an Eppendorf tube using a 5 mL sterile pipette. Trypan blue (three to five drops) was added to the tube. 100 μL of the Trypan blue-treated cell suspension was pipetted and transferred to the hemocytometer. If a glass hemocytometer was used, both chambers were gently filled underneath the coverslip, allowing the cell suspension to be drawn out by capillary action. If a disposable hemocytometer was used, the cell suspension was pipetted into the well of the counting chamber, allowing capillary action to draw it inside. A microscope was used to focus on the grid lines of the hemocytometer with a 10× objective.

On Day 3 (3^{rd} day after initiation), the results show that the lowest cell count (as compared to THPS only) was obtained from formulations MT+TT+THPS and MT+THPS, which have a 65% and 53% lower cell count, respectively (FIG. 2).

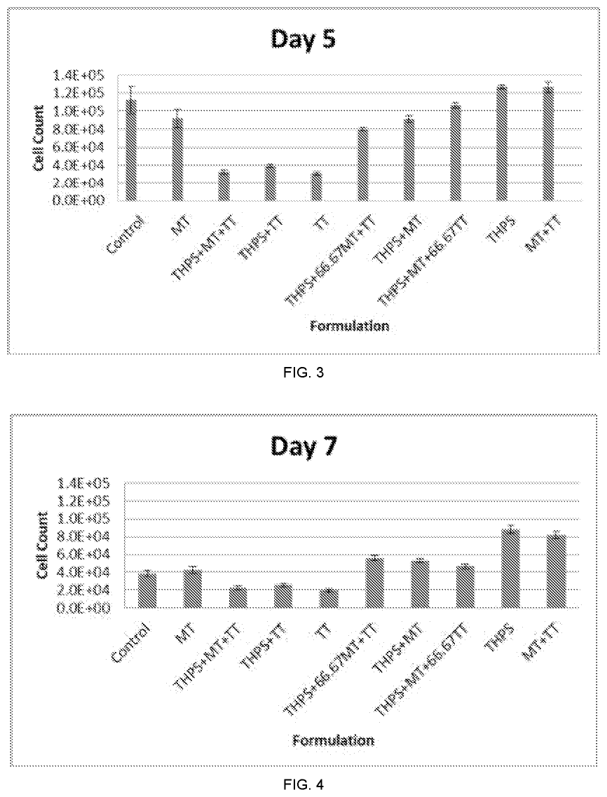

On Day 5, the lowest cell count (as compared to THPS only) was obtained from formulations MT+TT+THPS and TT, which have a 77% lower cell count (FIG. 3).

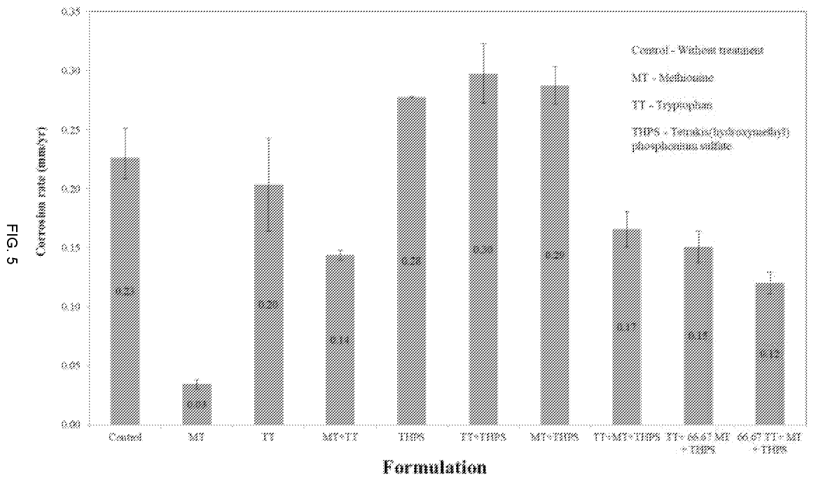

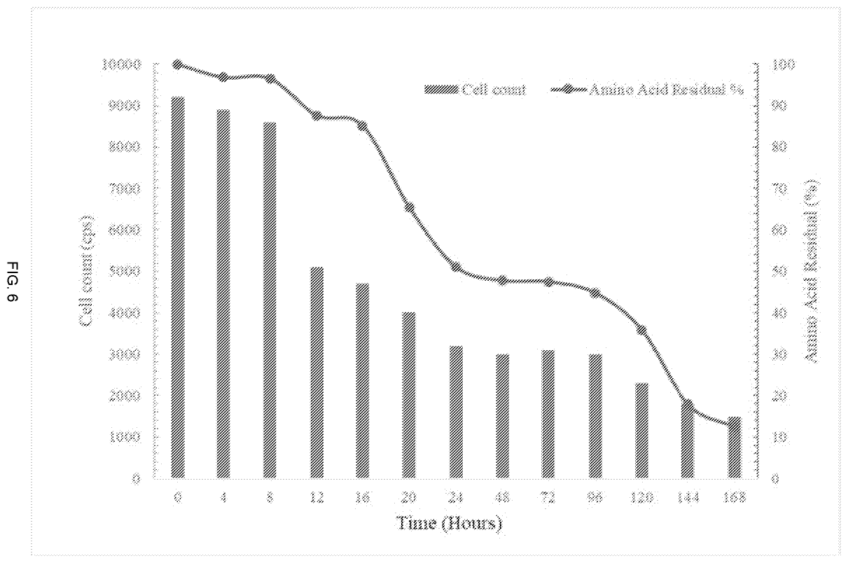

On Day 7, the lowest cell count (as compared to THPS only) was still obtained from formulations MT+TT+THPS and TT, both having a 78% lower cell count (FIG. 4). Furthermore, it is observed that 100 ppm of THPS alone could not suppress bacteria growth.

Overall, the results show that THPS alone is not sufficient to reduce bacteria growth. THPS was found to reduce cell count to a greater extent when combined with both D-methionine and D-tryptophan.

### Example 3

### Corrosion Rate and Surface Morphology

To determine the effect of D-amino acid(s) and/or THPS on bacteria growth and corrosion rates, carbon steel coupons were immersed in the formulations of Example 1 for seven days. After the test period, the corrosion rate of the coupons was estimated. The coupons were also analysed with SEM and EDX to characterise the surface morphology, corrosion products and the extent of pitting (if any).

3.1 Coupons Tested

The coupons tested was a quenched & tempered API 5L X65 carbon steel having a chemical composition as shown in Table 2. The coupons having a square shape (2.5 cm×2.5 cm×0.2 cm) were coated on the sides and bottom with Teflon paint to avoid any galvanic effect due to contact with the sample holder, leaving an exposed area of 4 cm².

TABLE 2
Chemical composition of steel coupon sample API
5L X65. Balance percentage consists of Fe.

| Al | As | B | C | Ca | Co | Cr | Cu |
|---|---|---|---|---|---|---|---|
| 0.032% | 0.008% | 0.001% | 0.13% | 0.002% | 0.007% | 0.14% | 0.131% |

| Mn | Mo | Nb | Ni | P | Pb | S | Sb |
|---|---|---|---|---|---|---|---|
| 1.16% | 0.16% | 0.017% | 0.36% | 0.009% | <0.001% | 0.009% | 0.009% |

| Si | Sn | Ta | Ti | V | Zr |
|---|---|---|---|---|---|
| 0.26% | 0.007% | <0.001% | <0.001% | 0.047% | <0.001% |

3.2 Coupon Preparation, Immersion Procedure and Corrosion Rate

Two coupons (X65 carbon steel) were immersed in each formulation for seven days. The temperature of the solutions was maintained between 35-40° C. Prior to each experiment, the coupons were polished with silicon carbide abrasive papers of up to 800 grit and isopropyl alcohol as coolant. Upon removal from the water or formulation, coupon surfaces were rinsed with isopropyl alcohol, dried, and stored in desiccators for further surface analysis. One of the two coupons was used for weight loss measurements, while the other coupon was preserved for further corrosion product evaluation.

ASTM G1-03 standard (“Standard Practice for Preparing, Cleaning and Evaluating Corrosion Test,” ASTM, Phidelphia, Pa., pp. 17-23, 2009) was followed to remove the corrosion products from the coupons. The corrosion rate was determined by weight loss of the coupons in accordance with SP0775-2013, “Standard Practice, Preparation, Installation, Analysis, and Interpretation of Corrosion Coupons in Oilfield Operations,” (Houston, Tex.: NACE). The corrosion rate was calculated using equation (1):

$$C R = \frac{{m}_{l o s s} \times 87.6}{{ρ}_{F e} \times A \times t} \qquad ( 1 )$$

where:
CR: calculated corrosion (mm/yr);
Mₗₒₛₛ: mass loss of steel sample (measured in grams);
ρ_{Fe}: density of iron (equal to 7.85 g/cm³);
A: surface area (in cm²); and
t: exposure time (in hours)

3.3 Results of Corrosion Rate Analysis

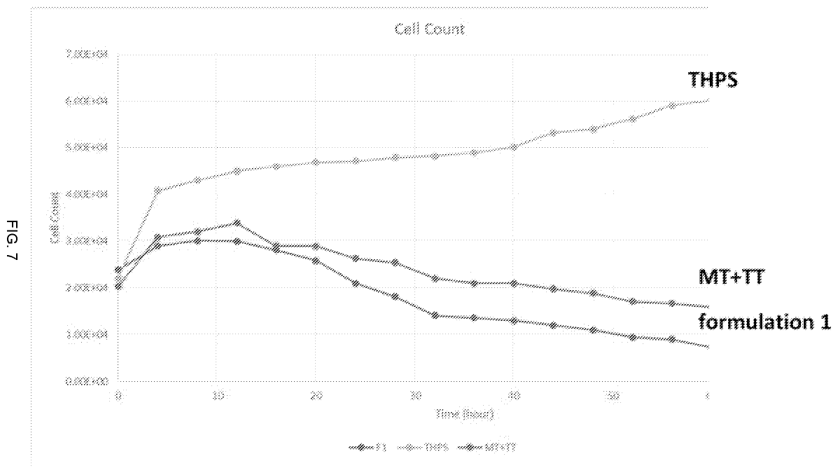

The calculated corrosion rate for the formulations is shown in FIG. 5. The lowest corrosion rate at 0.03 mm/yr was determined on formulation MT, followed by formulation 66.67TT+MT+THPS at 0.12 mm/yr. It is noted that THPS alone or combined with D-methionine alone (formulation MT+THPS) or D-tryptophan alone (formulation TT+THPS) was not effective to reduce the corrosion rate. Notably, the corrosion rate of formulations TT+MT+THPS and TT+66.67MT+THPS (0.17 and 0.15 mm/yr, respectively) are lower than the control formulation (0.23 mm/yr). It can be concluded that THPS needs to be combined with D-methionine and D-tryptophan to reduce the corrosion rate to around 0.1 mm/yr.

3.4 Corrosion Product Evaluation

Scanning electron microscopy (SEM) was used to study the morphology of the corrosion product on the coupon samples. Energy dispersive X-ray spectroscopy (EDS) microanalysis was used for further chemical analysis. Prior to SEM/EDS, the coupons were sputter coated with palladium.

The SEM images showed that all coupon samples were covered with black and yellow scale precipitate on the steel surface. This precipitation could be derived from the corrosion process which formed corrosion products such as iron carbide (Fe₃C) or iron oxide (FeO). In addition, the yellow scale could indicate the formation of biofilm.

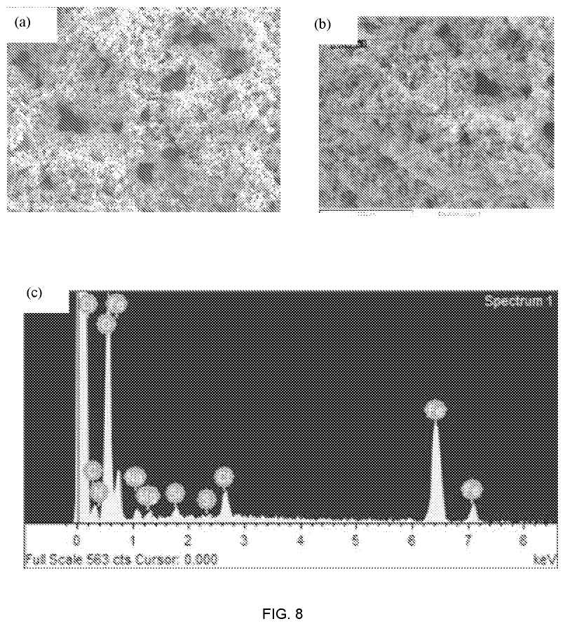

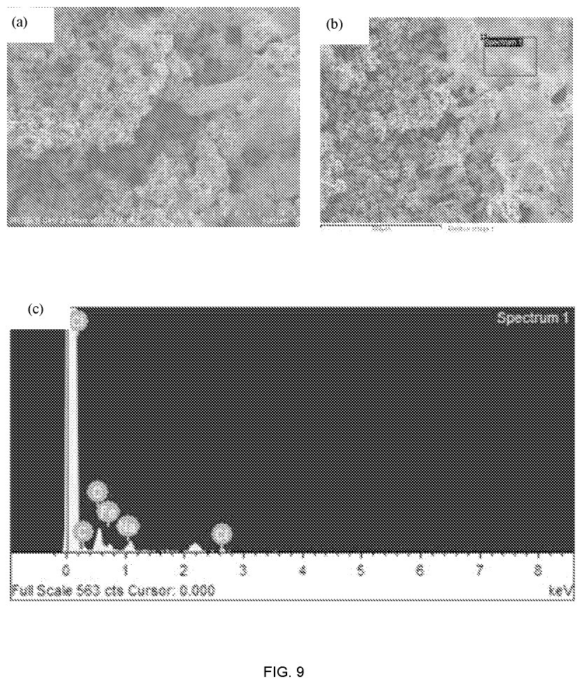

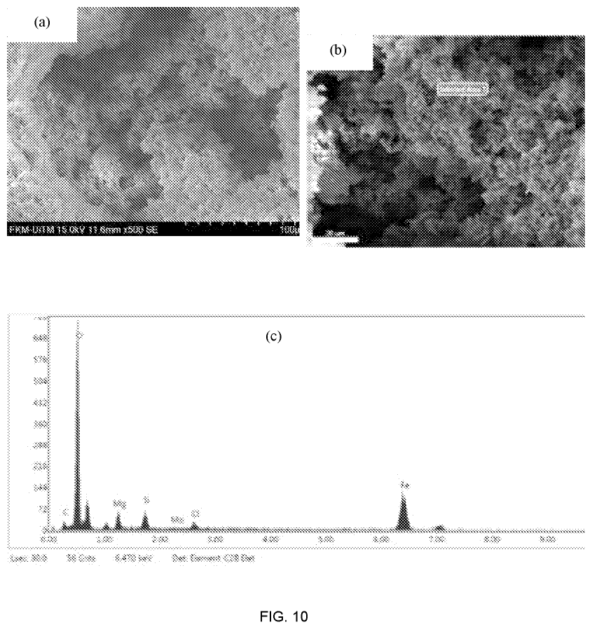

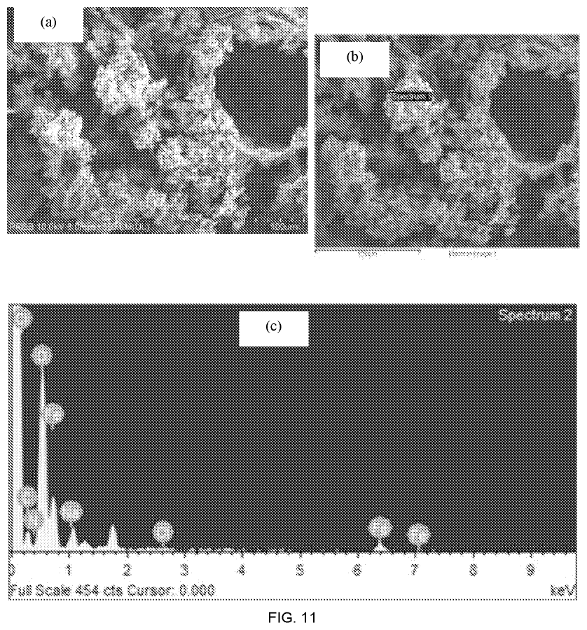

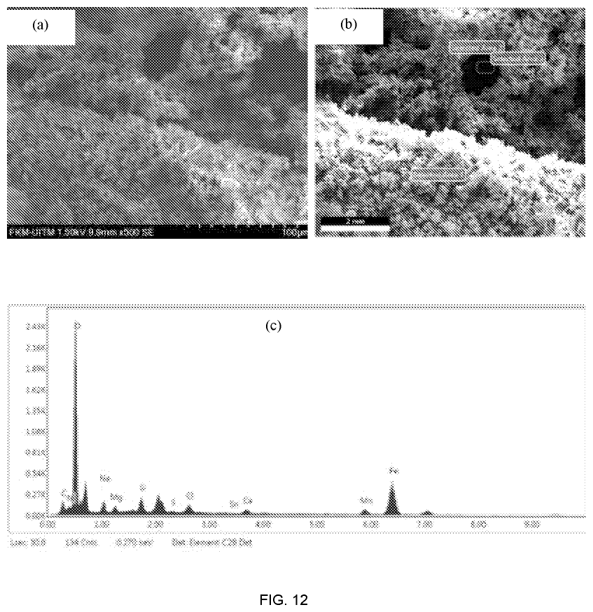

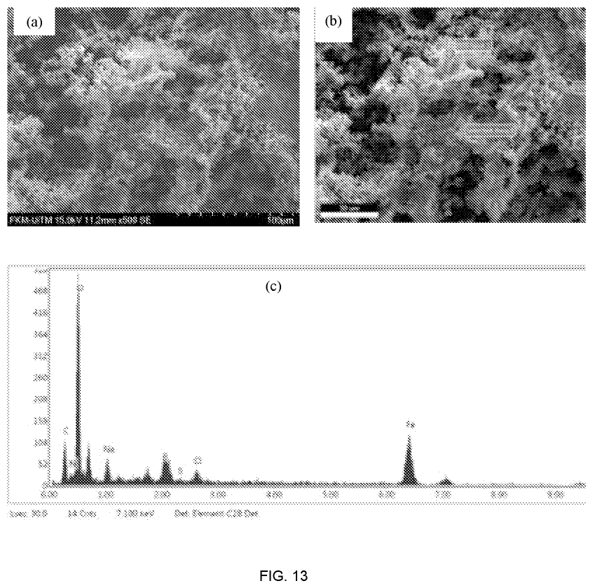

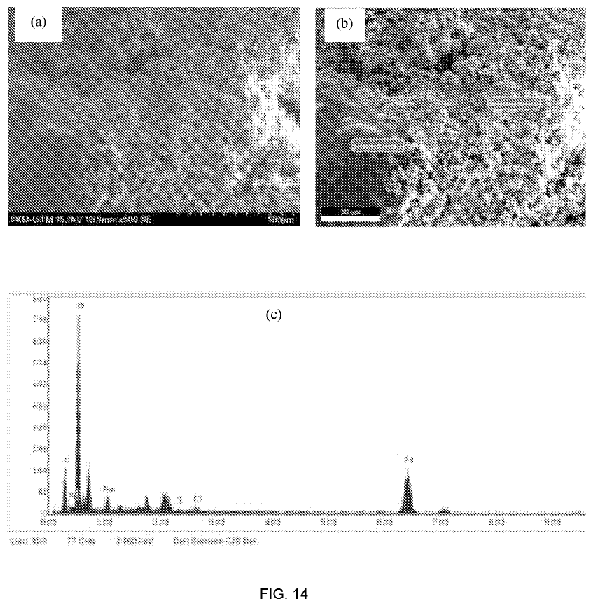

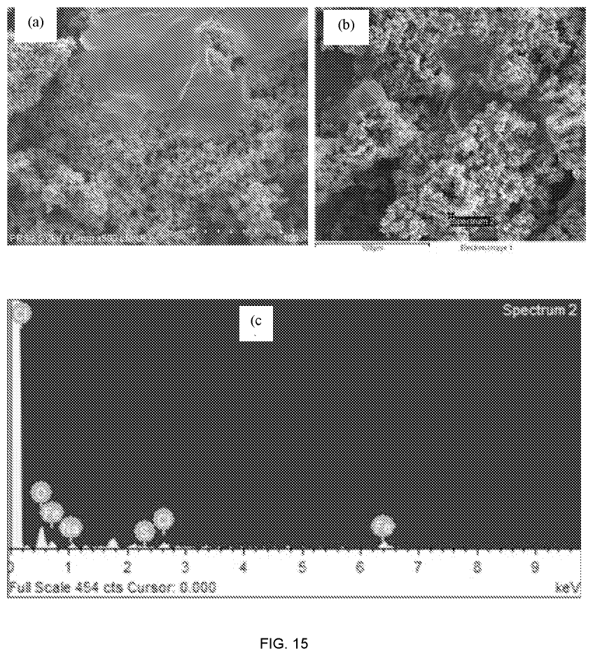

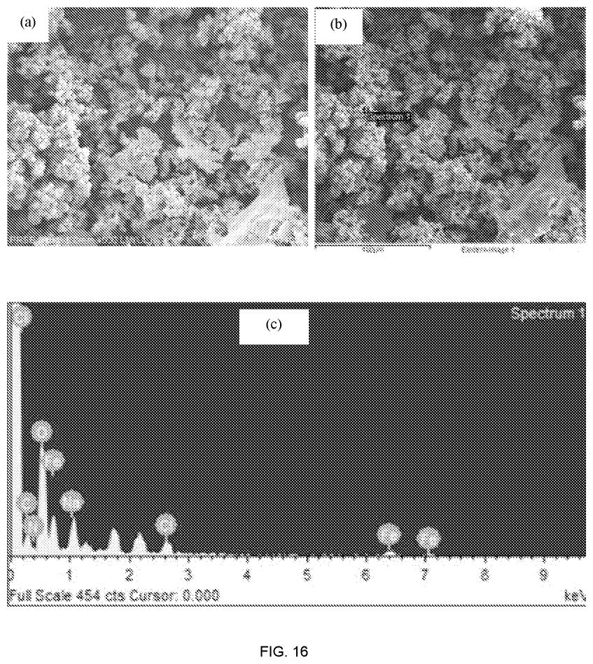

EDX analysis on all coupon samples showed the presence of Fe, O, and C, supporting that the hypothesis that iron oxide (FeO) or iron carbide (Fe₃C) are part of the corrosion product layer (FIGS. 8 to 16). FeS layer could also be found on the coupons for the control formulation and formulation TT+THPS, based on the presence of S in the EDX analysis of those samples. In addition, the EDX analysis on all coupon samples showed the presence of N and C, indicating the presence of a biofilm. It is believed that the scale and biofilm were formed by precipitation as they appeared as multiple layers which covered the whole surface of the steel.

3.5 Extent of Pitting

After removal of the corrosion product layer, a surface profile analysis was conducted using an optical profilometry microscope in order to identify topographical surface features due to corrosion. The corrosion product was removed from the steel coupons using Clarke solution in accordance with ASTM G1-03 standard.

The obtained images showed that no pitting was observed in all samples. It can be concluded that the steel coupon suffered from a uniform corrosion rate as discussed in 3.3.

If pitting could be observed on the steel surface, further analysis by profilometry analysis using microscope is needed to determine the depth of the pits. Pit penetration rate can be determined from the depth of the pitting. The pitting ratio can be determined by dividing the pit penetration rates with uniform corrosion rate. According to an internal procedure developed to evaluate pitting, any pitting ratio above the value of 5 would constitute a clear case of localised corrosion (ASTMG46-94, “Standard Guide for Examination and Evaluation of Pitting Corrosion,” ASTM, Philadelphia, Pa., pp. 1-7, 1999). In this case, no localised corrosion was observed.

### Example 4

### Optimised Biocide Formulation

Two optimised biocide formulations were determined based on the results of Examples 2 and 3 (Table 3). The experimental results of Examples 2 and 3 were fed to a Design of Experiment software (Design Expert 9) to provide a model that can recommend formulations depending on project requirements. The two formulations were recommended by the model based on the requirement of minimising cell dry weight and corrosion rate, and having a cost within a range.

Both formulations showed similar results in terms of cell dry weight and corrosion rate. However, formulation 1 was subjected to further tests as elaborated in subsequent examples because it was estimated to involve a lower cost as compared to formulation 2.

TABLE 3
Optimised Biocide Enhancer Formulation. The cell dry weight
and corrosion rate values in Table 3 were predicted from
the model. These predicted values were verified from experiments,
where the values fall within a confidence interval.

| | |
|---|---|
| Formulation 1 | 30 ppm THPS, 9 ppm D-Methionine, 61 ppm D- |
| | Tryptophan |
| | Cell Dry Weight = 0.00478 g/ml |
| | Corrosion Rate = 0.11 mm/yr |
| | Estimate Cost = RM 44,899/yr (vs RM 109K) |
| Formulation 2 | 28 ppm THPS & 72 ppm D-Tryptophan |
| | Cell Dry Weight = 0.00491 g/ml |
| | Corrosion Rate = 0.10 mm/yr |
| | Estimate Cost = RM 46,958/yr (vs RM 109K) |

Comparative Results

The cell dry weight and corrosion rate values for other formulations are provided in Table 4. It can be seen that the comparative formulations give a worse result than formulation 1, as evident from the higher cell dry weight and corrosion rates.

TABLE 4
Comparative formulations. The cell dry weight and corrosion
rate values in Table 4 were predicted from the model.

| | | | | 1^{st} | 2^{nd} |
|---|---|---|---|---|---|
| | | | | Priority | Priority |
| | | D- | D- | Cell Dry | Corrosion |
| Formulation | THPS | methionine | tryptophan | Weight | Rate |
| name | (ppm) | (ppm) | (ppm) | (g/ml) | (mm/yr) |
| Formulation | 30 | 9 | 61 | 0.00478 | 0.114257 |
| 1 | | | | | |
| Comparative | 30 | 6.6 | 6.6 | 0.00499 | 0.214198 |
| formulation | | | | | |
| 1 | | | | | |
| Comparative | 30 | 3.3 | 3.3 | 0.00566 | 0.238143 |
| formulation | | | | | |
| 2 | | | | | |

### Example 5

### Biocide Residual Test

Formulation 1 of Example 4 was subjected to a residual test to determine the concentration of the D-amino acids that would remain seven days after injection into a setup that simulate a pipeline.

5.1 Experimental Setup

A mini flow loop was assembled, the loop consisting of a tank and piping material connected to and from the tank in a loop. The piping was made of PVC and of 2 inches in diameter. The tank was 12 litres in volume. An immersible water pump was used to circulate the water at a maximum water velocity of 2 m/s. The water temperature was 30° C.

The tank was filled with 12 litres of a brine composition (sample B04S). For the first two days, the loop was running without addition of biocide in order to establish a bacteria population in the entire flow loop, including the pipings and tank. On Day 3, formulation 1 was injected (this point is shown as “0 hour” in FIG. 6. After injection, water samples were collected every four hours until Day 10 to determine the residual percentage of the D-amino acids via UV-visible spectroscopy and bacteria cell count in the water via the procedure in 2.2.

5.2 Results

The results show that both the cell count and concentration of formulation 1 decreased over the entire course of the experiment (FIG. 6). It is believed that the D-amino acids were utilised to kill the bacteria in the water. Only 12% of the amino acids (as a percentage of the amino acid concentration in the first water sample) remain in the mini flow loop after seven days. This suggests that the formulation should be re-applied every 7 days.

It is noted that formulation 1 started to kill the bacteria 4 hours following the injection of formulation 1 as the cell count was reduced after 4 hours and continued to show a decreasing profile.

### Example 6

### Time Kill Test

Another test was conducted to determine the time needed after injection of formulation 1 before a drop in bacteria population is observed. The test was conducted in accordance to ASTM Standard E 2315-03, “The Standard Guide for Assessment of Antimicrobial Activity Using a Time Kill Procedure,” ASTM, Phidelphia, Pa., pp. 1-5, 2016. The test was repeated with three formulations (THPS, MT+TT and formulation 1). The total duration for each test was 60 hours.

Results and Discussion

The time for formulation 1 was recorded at 12 hours and MT+TT at 16 hours (FIG. 7). With formulation 1, cell growth was observed from 0-8 hours and significant cell death started from 12 hours to 60 hours to a sufficiently low cell count that will not lead to any growth increment even after 60 hours.

As shown in FIG. 7, both formulations 1 and MT+TT were found to reduce cell growth. As compared to the formulations THPS and MT+TT, formulation 1 showed the lowest cell count throughout the whole duration of the test.

The test results were in line with those of the residual test in Example 5, with slight differences. In the residual test, only 4 hours was needed for formulation 1 to start killing the bacteria, while the time kill test needed 12 hours. This difference could be explained due to the difference in the nature of the tests. The time kill test was conducted in vials (in static conditions), while the residual test was a dynamic test involving the mini flow loop set-up with a flow rate and higher volume. In addition, in the residual test, formulation 1 was injected at day 3 after cell growth rate reached its significant value. Bacteria growth in vials were rapid due to less stress (no flow) and therefore the number of cells were higher as compared to that of the residual test, where large volume and diffusion of water facilitate the killing process of the bacteria. The water flow helped the biocide enhancer (formulation 1) to diffuse faster which lead to a lower killing time.

It can be concluded that formulation 1 exhibited antimicrobial capability in a short time.

Without wishing to be bound by theory, it is believed that excess D-tryptophan and D-methionine disrupts the chemical bonds in the peptidoglycan cell wall of bacteria. Specifically, these amino acids disrupt the crosslink between the polysaccharide chains by breaking the bond between N-acetylglucosamine and N-acetylmuramic acid. The disruption of the cell wall in turn reduces cell growth.

1. A composition for treating bacteria growth on a substrate, the composition comprising:
a biocide; and
at least one D-amino acid.

2. The composition according to claim 1, wherein the composition further comprises water.

3. The composition according to claim 1, wherein the D-amino acid is selected from one or more of the group consisting of D-tyrosine, D-methionine, D-tryptophan, D-leucine, D-arginine, D-histidine, D-lysine, D-aspartic acid, D-glutamic acid, D-serine, D-threonine, D-asparagine, D-glutamine, D-cysteine, D-proline, D-alanine, D-valine, D-isoleucine, D-phenylalanine and a non-standard D-amino acid.

4. The composition according to claim 1, wherein the biocide is selected from one or more of the group consisting of tetrakis hydroxymethyl phosphonium sulfate (THPS), chlorine monoxide, chlorine dioxide, calcium hypochlorite, potassium hypochlorite, sodium hypochlorite, dibromonitriloproprionamide (DBNPA), methylene bis(thiocyanate) (MBT), 2-(thiocyanomethylthio) benzothiazole (TCMTB), bronopol, 2-bromo-2-nitro-1,3-propanediol (BNPD), tributyl tetradecyl phosphonium chloride (TTPC), taurinamide and derivatives thereof, phenols, quaternary ammonium salts, chlorine-containing agents, quinaldinium salts, lactones, organic dyes, thiosemicarbazones, quinones, carbamates, urea, salicylamide, carbanilide, guanide, amidines, imidazolines, acetic acid, benzoic acid, sorbic acid, propionic acid, boric acid, dehydroacetic acid, sulfurous acid, vanillic acid, p-hydroxybenzoate esters, isopropanol, propylene glycol, benzyl alcohol, chlorobutanol, phenylethyl alcohol, formaldehyde, iodine and solutions thereof, povidone-iodine, hexamethylenetetramine, noxythiolin, 1-(3-chloroallyl)-3,5,7-triazo-l-azoniaadamantane chloride, taurolidine, taurultam, N-(5-nitro-2-furfurylidene)-1-amino-hydantoin, 5-nitro-2-furaldehyde semicarbazone, 3,4,4′-trichlorocarbanilide, 3,4′,5-tribromosalicylanilide, 3-trifluoromethyl-4,4′-dichlorocarbanilide, 8-hydroxyquinoline, 1-cyclopropyl-6-fluoro-1,4-dihydro-4-oxo-7-(1-piperazinyl)-3-quinolinecarboxylic acid, 1,4-dihydro-1-ethyl-6-fluoro-4-oxo-7-(1-piperazinyl)-3-quinolinecarboxylic acid, hydrogen peroxide, peracetic acid, sodium oxychlorosene, parachlorometaxylenol, 2,4,4′-trichloro-2′-hydroxydiphenol, thymol, chlorhexidine, benzalkonium chloride, cetylpyridinium chloride, silver sulfadiazine, silver nitrate, bromine, ozone, isothiazolones, polyoxyethylene (dimethylimino) ethylene (dimethylimino) ethylene dichloride and 2-(tert-butylamino)-4-chloro-6-ethylamino-5′-triazine (terbutylazine).

5. The composition according to claim 1, wherein the weight to weight ratio of the at least one D-amino acid to the biocide is from 0.5 to 50:1.

6. The composition according to claim 1, wherein the composition comprises at least two D-amino acids.

7. The composition according to claim 6, wherein the weight to weight ratio of the at least two D-amino acids to the biocide is from 0.5 to 50:1.

8. The composition according to claim 1, wherein the at least one D-amino acid is D-tryptophan.

9. The composition according to claim 1, wherein the at least one D-amino acid is D-tryptophan and D-methionine.

10. The composition according to claim 9, wherein the weight to weight ratio of D-tryptophan to D-methionine is from 2 to 20:1.

11. The composition according to claim 1, wherein the biocide is tetrakis

12. The composition according to claim 1, wherein:
the at least one D-amino acid is D-tryptophan and D-methionine; and
the biocide is tetrakis hydroxymethyl phosphonium sulfate (THPS).

13. The composition according to claim 12, wherein:
(a) the weight to weight ratio of D-tryptophan to D-methionine is from 2 to 20:1, and the weight to weight ratio of the D-amino acids to THPS is from 0.5 to 50:1; or
(b) the weight to weight ration of D-tryptophan to D-methionine is from 4 to 10:1, and the weight to weight ratio of the D-amino acids to THPS is from 1.5 to 5:1.

14. (canceled)

15. The composition according to claim 12 wherein, when no solvent or water is present:
D-tryptophan is present in an amount of 61 wt %;
D-methionine is present in an amount of 9 wt %; and
THPS is present in an amount of 30 wt %.

16. The composition according to claim 12 wherein, when the composition further comprises water, the composition consisting of:
(a) 61 ppm of D-tryptophan;
9 ppm of D-methionine; and
30 ppm of THPS,
with the balance being water; or
(b) 610 ppm of D-tryptophan;
90 ppm of D-methionine; and
300 ppm of THPS,
with the balance being water.

17. A process of treating bacteria growth on a substrate, which process comprises contacting the substrate with a composition as defined in claim 1.

18. The process according to claim 17, wherein the biocide and the at least one D-amino acid are separately and sequentially added to a medium that contacts the substrate.

19. The process according to claim 18, wherein the medium is water or a water/oil mixture.

20-21. (canceled)

22. The composition according to claim 1, where the bacteria to be treated is selected from one or more of group consisting of Bacillus sp., Bacillus thuringiensis and Marine actinomycetes.

23. The process according to claim 17, where the bacteria to be treated is selected from one or more of group consisting of Bacillus sp., Bacillus thuringiensis and Marine actinomycetes.
